(19) United States
(12) Patent Application Publication
(10) Pub. No.: US 2024/0224980 A9
(43) Pub. Date: Jul. 11, 2024

(54) APPARATUS AND METHOD FOR CONTROLLING WEED GROWING ON A GROUND SURFACE

(71) Applicant: FORTITUDE HOLDING AS, SLITU (NO)

(72) Inventors: Hendrik Van De Haar, Wekerom (NL); Jan Van Hensbergen, Ede (NL)

(73) Assignee: ncdh Group AG, Zurich (CH)

(21) Appl. No.: 18/278,464

(22) PCT Filed: Feb. 23, 2022
(86) PCT No.: PCT/EP2022/054552

§ 371 Date: Aug. 23, 2023

(30) Foreign Application Priority Data
Feb. 23, 2021 (NL) 2027627

(51) Int. Cl. A01M 21/04; A01M 7/00

(52) U.S. Cl. CPC A01M 21/04; A01M 7/0085

(57) ABSTRACT

An apparatus for controlling weed growing on a ground surface includes a liquid supply system configured to supply hot liquid, and dispensing means are operatively connected to the liquid supply system. The dispensing means are configured to dispense hot liquid to the weed. The liquid supply system includes at least one buffer tank that is configured to store and supply hot liquid, a liquid supply container is connected to the at least one buffer tank, and a direct supply line extends between the supply container and the at least one buffer tank. The direct supply line is configured to supply unheated liquid from the supply container directly to the at least one buffer tank and a hot liquid supply line including heating means for heating liquid supplied from the supply container to the at least one buffer tank. A method for controlling weed growth.

The invention relates to an apparatus and method for controlling weed growing on a ground surface and to a liquid supply system suitable for an apparatus controlling weed growing on a ground surface.

Several different apparatus and methods for controlling weed growth are known from practice. A first group of such apparatus employ chemical weed killers that are supplied from a tank to dispensing means, which in turn spray it onto the weeds to be removed. A disadvantage thereof is that such chemicals often comprise a risk for both humans and the environment.

A second group of apparatus employs brushes, often steel brushes, to remove weed from a surface to be cleaned by rotating the brushes over the surface. Although such brushes are highly effective in removing weeds, they have the disadvantage that the weeds, often accompanied by pebbles, are ejected at high velocity by the brushes. This incurs damage to surrounding vehicles, people and/or buildings. In addition, such brushing apparatus require a high amount of investment.

It is further also possible to employ hot air and/or gas burners such that the hot air or the gas flame is applied directly to the weeds to be removed. This however provides risk of damaging and/or burning people and/or objects in the vicinity of the stream of hot air and/or the gas flame. In case of a gas flame, this may also lead to a (spreading of) fire.

Another known, and increasingly employed alternative is an apparatus employing hot water to remove weed from pavements and roads. Such an apparatus provides a cost effective and/or more environmentally friendly alternative than the other options described above.

Such known apparatus comprise means for storing and feeding hot water that is operatively connected to dispensing means for dispensing the hot water to weeds to be removed. The means for storing and feeding hot water often include at least one buffer tank in which hot water is stored. The apparatus further comprises a supply container in which unheated liquid is stored. During use of the apparatus, the unheated liquid is heated to an operating temperature when it flows from the supply container to the at least one buffer tank. This means that, during flowing, one or more burners heat the flow to a temperature in excess of 70° C., and preferably even to a temperature up to 100° C. or higher.

A disadvantage of the known apparatus is that multiple, high capacity burners are required to supply the significant amount of energy that is needed to heat the water flowing from the supply container to the buffer tank.

The invention is aimed at providing an improved apparatus in which the amount of required energy is reduced.

To that end, the invention provides an apparatus controlling weed (W) growing on a ground surface, (S), the apparatus comprising:
a liquid supply system that is configured to supply hot liquid; and
dispensing means that are operatively connected to the liquid supply system, wherein the dispensing means are configured to dispense hot liquid to weed on the ground surface (S);
   wherein the liquid supply system comprises:
at least one buffer tank that is configured to store and supply hot liquid;
a liquid supply container that is connected to the at least one buffer tank;
a direct supply line extending between the supply container and the at least one buffer tank, the direct supply line being configured to supply liquid from the supply container directly to the at least one buffer tank, and
a hot liquid supply line that includes heating means for heating the liquid supplied from the supply container to the at least one buffer tank.

An advantage of the apparatus according to the invention is that the direct supply line for liquid allow the heating means in the hot liquid supply line to be operated more efficiently. This is due to the fact that the liquid for the buffer tank in the apparatus according to the invention is provided partially through the direct supply line and (only) partially through the hot liquid supply line. As a result, the heating means can be operated, preferably intermittently, at a lower heating capacity. This increases energy efficiency of the heating means and, therewith, reduces energy use.

The presence of the direct supply line in the apparatus according to the invention also provides the advantage that the flow rate and the pressure in the hot liquid supply line can be reduced. As a result, the required amount of energy is reduced even further.

These advantages are achieved by means of the direct supply line in the apparatus according to the invention. Instead of providing all liquid to the buffer tank via the heating means as is known from prior art apparatuses, the liquid in the buffer tank in the apparatus according to the invention is partially supplied via the direct supply line and partially via the hot liquid supply line. This means that the liquid flow in the direct supply line can be used to achieve a desired (set-point) temperature of the liquid in the at least one buffer tank.

In an elaboration, the effectivity and energy reduction of the apparatus according to the invention can be increased even further by providing warm or hot water to the supply container. In that case, the amount of liquid provided via the hot liquid supply line and the heating means to the buffer tank can be reduced even further to achieve a desired temperature in the buffer tank due to the higher temperature of the liquid supplied through the direct supply line.

In an embodiment according to the invention, the apparatus further comprises a drain line that extends between the buffer tank and the supply container and that is configured to discharge liquid from the buffer tank to the supply container.

An advantage of a drain line is that overfilling of the at least one buffer tank is substantially prevented by transferring liquid from the buffer tank to the supply container. As such, the drain line can be used to regulate the liquid level in the at least one buffer tank.

Another advantage is that, when transferring liquid from the at least one buffer tank, the temperature of the transferred liquid is relatively high. This increases the temperature of the (unheated) liquid in the supply tank and, therewith, reduces the amount of energy that the heating means need to supply to the liquid when it is supplied from the supply container to the at least one buffer tank via the hot liquid supply line.

Yet another advantage is that the drain line additionally or alternatively also may be used to discharge liquid from the at least one buffer tank if the temperature of the liquid in the at least one buffer tank is lower than a predetermined temperature. In such case, the liquid level may be reduced to a predetermined minimum liquid level in the at least one buffer tank.

In an embodiment according to the invention, the drain line comprises a drain valve that is connected to the at least one buffer tank or positioned in the drain line for regulating the discharge.

It is preferred that the drain line comprises a drain valve, which, preferably together with the mixing valves, can be used to regulate the liquid level in the at least one buffer tank. In an embodiment, the drain valve may be regulated by a control unit, which may also be connected to mixing valves to provide an (even more) integral control.

In an embodiment according to the invention, the direct supply line comprises one or more mixing devices, wherein the one or more mixing devices preferably comprise mixing valves and more preferably comprise one or more temperature controlled mixing valves.

An advantage of applying one or more mixing devices is that these devices can be used to achieve and/or maintain the liquid in the buffer tank at a constant temperature. This is achieved by mixing the flow of liquid to the buffer tank with the flow of hot liquid from the hot liquid supply line using the mixing device(s). As a result, a desired temperature in the at least one buffer tank can be achieved or maintained by manipulating the liquid flow in either the direct supply line or the liquid flow flowing through the hot liquid supply line (or both). This allows more flexibility to achieve the desired temperature in the at least one buffer tank.

In an embodiment according to the invention, the direct supply line comprises at least one signal-generating temperature sensor, wherein the one or more mixing devices are configured to be controlled based on the signals generated by the at least one temperature sensor. This allows the temperature in the at least one buffer tank to be regulated based on the information obtained from the temperature sensor.

In an embodiment according to the invention, the apparatus comprises a number of additional signal-generating temperature sensors.

An advantage is that, by monitoring the temperatures of the various liquid flows in the apparatus using the temperature sensors, a more intricate control of the temperature of the liquid in the apparatus, especially the at least one buffer tank, is obtained. This allows the heating means to be controlled in a more detailed and information-driven manner, thus reducing the energy requirements even further. It is for example conceivable to provide temperature sensors in one or more of the at least one buffer tank, the water tank and the heating means.

In an embodiment according to the invention, wherein one or more of the hot liquid supply line, the direct supply line, and/or the drain line are provided with a pump.

An advantage of one or more pumps is that the liquid is more easily displaced through the lines of the apparatus.

Another advantage is that the pump(s) may be used to provide pressure to a fluid line in which it is positioned. This is especially relevant if the buffer tank is provided as a pressure tank, because it requires the fluid stream via the direct supply line to be pressurized to allow the transport of the fluid from the supply container to the buffer tank.

In an embodiment according to the invention, the liquid supply system is configured to, during use of the apparatus, replenish the at least one buffer tank with hot liquid from the heating means, and to drain any excess liquid from the buffer via the drain line to the supply container in order to avoid overfilling of the buffer tank.

By replenishing liquid in the at least one buffer tank with hot liquid from the heating means, which preferably only takes place if the temperature of the liquid in the direct supply line is insufficiently high to achieve a desired set point temperature in the buffer tank, the heating means can be operated at a relatively low flow rate and a relatively low pressure, which reduces energy consumption of the heating means. Simultaneously, the liquid level in the at least one buffer tank is regulated by the drain line by removing excess liquid (i.e. liquid rising above a predetermined threshold) to the supply container. This drained liquid, due to its increased temperature, also increases the temperature of the liquid in the supply container. As a result, the liquid flowing to the heating means also has an increased temperature, which in turn reduces the amount of energy needed to (further) increase the temperature of the liquid to obtain hot liquid.

In an embodiment according to the invention, wherein the supply container and/or the at least one buffer tank are insulated.

It is preferred to insulate the at least one buffer tank and, in some cases, the supply container. An advantage is that heat provided by the heating means is, at least partially, conserved.

Another advantage of this embodiment is that it also allows hot or warm liquid to be provided to the supply container when it is filled from an external source of liquid. The insulation prevents or at least significantly reduces the heat losses to the environment and retains an increased temperature in the supply container. This decreases the amount of energy required that the heating means needs to provide to the liquid to heat it to the desired temperature (hot liquid).

In an embodiment according to the invention, additionally or alternatively one or more of the liquid supply line may also be insulated.

In an embodiment according to the invention, wherein the hot liquid supply line is connected to the direct supply line directly downstream of the one or more mixing devices.

An advantage of this construction is that the hot liquid flow and the liquid flow from the direct supply line are mixed before entering the at least one buffer tank, which provides a more even temperature profile.

A construction in which the direct supply line and the hot liquid supply line both (independently from each other) emanate in the at least buffer tank is however also possible. The mixing device in such a case is either the buffer tank itself, or a mixing device provided in the buffer tank. It is within the present invention even possible to provide an embodiment in which the direct supply line emanates in or merges with the hot liquid supply line near or directly adjacent to its connection with the at least one buffer tank.

In an embodiment according to the invention, the heating means comprise a number of burners, such as gas-fueled or diesel-powered burners, and/or a number of electrical heating elements.

Due to the direct supply line and the associated (reduced) heating requirements of the heating means, the heating means may be provided as a single burner, such as a burner with a low heating capacity, or may be provided as an electric heater or electric heating element(s).

In an embodiment according to the invention, the apparatus further comprises a frame that is configured to support the apparatus over the ground surface (S).

In order to transport the apparatus, the apparatus preferably comprises a frame, which may be provided with wheels. The frame may, in various embodiments, perform various functions. The frame may for example serve as a basis in case the apparatus is a self-propelling apparatus. The frame may be also be configured to be couplable to a vehicle, such as a car and/or tractor, to allow the frame to be towed. In addition, the frame may be designed to, alternatively or additionally, be couplable to and mountable on a vehicle, such as a car and/or tractor in order to be carried thereby. This includes for example mounting on a (front) of a tractor.

In an embodiment according to the invention, the apparatus further comprises a control unit that is configured to control one or more of hot liquid distribution from the buffer tank to the dispensing means and/or the liquid supply from the supply container to the at least one buffer tank via the direct and/or hot liquid supply line and/or the liquid discharge from the at least one buffer tank to the supply container via the drain line.

An advantage of providing a control unit is that a more integrated temperature and low control can be obtained. This is specifically true with regard to the flow and temperature profile of the liquid flowing to and/or from the at least one buffer tank.

In an embodiment according to the invention the apparatus further comprises search and/or detection means that are configured to search for and/or detect the weed (W), wherein the hot liquid is only dispensed onto or in the direct vicinity of detected weed (W) plants.

An advantage of this embodiment is that search for and/or detection of weed takes place automatically, which reduces errors in the spraying such as for example subjectivity through human observation.

In an embodiment according to the invention, the at least one buffer tank is a pressure tank that, during use, is pressurized, wherein the pressure is in the range of 0.2-4 bar, and preferably is in the range of 1-3 bar.

Pressurizing the at least one buffer tank provides several advantages. A first advantage is that the temperature of the liquid in the at least one buffer tank may be provided at a temperature in excess of 100° C. Another advantage is that the pressure may also be used to urge the hot liquid to the dispensing openings, therewith reducing temperature loss and reducing the response time of the apparatus.

In an embodiment according to the invention, the direct supply line may comprise a splitter that is configured to selectively supply, via a return line, at least part of the liquid from the direct supply line to the hot liquid supply line and/or the heating means.

An advantage of the splitter is that the liquid flow in the direct supply line may, instead of being reduced, also be rerouted to the hot liquid supply line (upstream of the heating means) or to the heating means. This is especially relevant if the temperature in the direct supply line is found to be below a predetermined value, because part of the liquid flow is than rerouted to the heating means for (additional) heating.

In an embodiment according to the invention, the dispensing means comprise dispensing openings that are positioned in a ring-shaped discharge line connected to the at least one buffer tank, wherein the dispensing openings are preferably provided with valves to open and/or close the dispensing openings.

By providing a ring-shaped discharge line in which the dispensing openings are positioned, the (hot) liquid can easily be circulated from and to the at least one buffer tank to, when needed, supply hot liquid having the desired temperature.

In an embodiment according to the invention, the control unit is adapted to determine and control an opening duration and/or a degree of opening of the valves.

By adapting the control unit to control the closing and/or opening time and/or the degree of opening of the valves of the dispensing openings, an increased efficiency is achieved. Furthermore, it reduces liquid use and, subsequently, the amount of energy required to heat the liquid in the apparatus.

In an embodiment according to the invention, the apparatus comprises at least one speedometer that is connected in signal-generating manner to the control unit, wherein the opening duration and/or the degree of opening of the valves is performed on the basis of a signal generated by the speedometer.

By coupling the duration and degree of opening of the valves associated with the dispensing openings with the speedometer, an even further increase in efficiency and accuracy is be achieved.

In an embodiment according to the invention, the liquid is (hot) water and/or (hot) water supplemented with one or more additions, such as de-hardening compounds and/or biological compounds that remove and/or reduce weed growth.

The invention further relates to a method for controlling weed (W) growing on a ground surface, comprising the steps of:
providing an apparatus according to any one of the preceding claims;
during operation supplying hot liquid, via the hot liquid supply line, to the at least one buffer tank; and
dispensing hot liquid, via the dispensing means, to weed on the ground surface that is to be controlled.

The method according to the invention provides similar effects and advantages as the apparatus according to the invention. It is noted that the above-mentioned embodiments of the apparatus may lead to associated methods steps and these embodiments may similarly be applied to the method according to the invention.

In an embodiment of the method according to the invention, the method further comprises the step of via the drain line draining excess liquid from the at least one buffer tank to the supply container to avoid overfilling of the buffer tank.

In an embodiment of the method according to the invention, the step of draining comprises the steps of measuring a liquid level in the at least one buffer tank, opening a drain valve in the drain line and/or the at least one buffer tank if the liquid level exceeds a level threshold, draining excess liquid from the at least one buffer tank to the supply container and closing the drain valve after the liquid level has dropped below the level threshold.

The invention also relates to a liquid supply system that is configured to be used in an apparatus for controlling weed (W) growing on a ground surface (S), the liquid supply system comprising:
at least one buffer tank that is configured to store and supply hot liquid;
a liquid supply container that is connected to the at least one buffer tank;
a direct supply line extending between the supply container and the at least one buffer tank, the direct supply line being configured to supply liquid from the supply container directly to the at least one buffer tank; and
a hot liquid supply line that includes heating means for heating the liquid supplied from the supply container to the at least one buffer tank.

The liquid supply system according to the invention provides similar effects and advantages as the apparatus and the method according to the invention. It is noted that the abovementioned embodiments of the apparatus and/or method may also be applied to the liquid supply system according to the invention.

The invention also relates to the use of a liquid supply system according to the invention or an apparatus according to the invention for controlling weed (W) growing on a ground surface (S).

The use of the liquid supply system or the apparatus according to the invention provides similar effects and advantages as the apparatus, the method and the liquid supply system according to the invention. It is noted that the abovementioned embodiments of the apparatus and method may similarly be applied to the use according to the invention.

Further advantages, features and details of the invention are elucidated on the basis of preferred embodiments thereof, wherein reference is made to the accompanying drawings, in which:

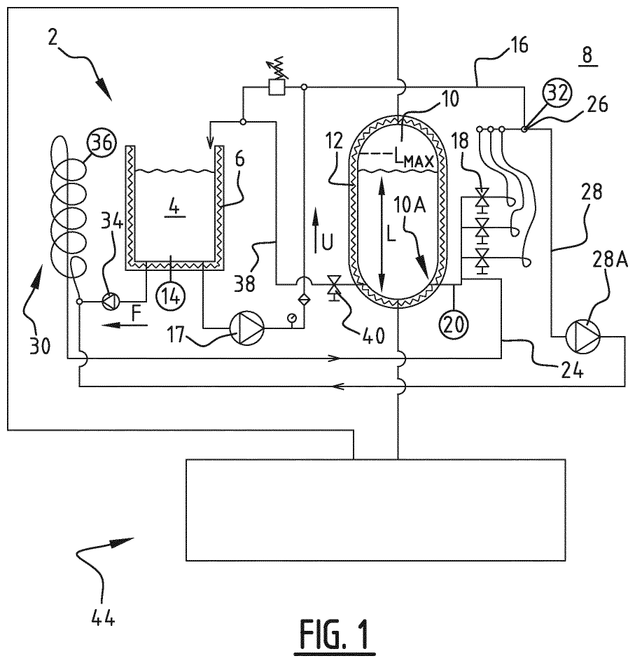

FIG. 1 shows a schematic example of an apparatus according to the invention;

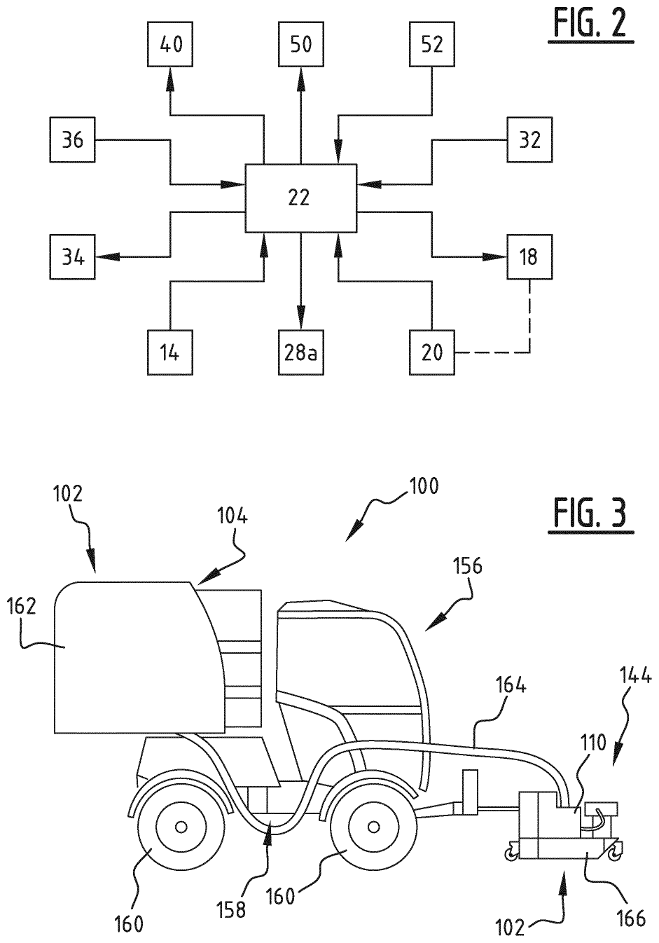

FIG. 2 shows a schematic view of an example of a part of the apparatus comprising the control unit; and

FIG. 3 shows a schematic side view of an example of a vehicle carrying an apparatus according to the invention.

In an example of apparatus 2 (see FIG. 1), apparatus 2 comprises supply container 4 in which a large quantity of liquid, in this example water, can be stored. Essentially, supply container 4 in this example is water tank 4. Supply container 4 in this example is insulated supply container 4 having insulation layer 6. Due to insulation layer 6 supply container 4 can not only be provided with cold water, yet also with (pre-)heated water having a higher temperature (without incurring heat loss to the environment 8). Supply container 4 further comprises temperature sensor 14, which is used to generate temperature information about the stored water in supply container 4.

Apparatus 2 further comprises buffer tank 10, which is provided with insulation layer 12. Buffer tank 10 in this example is configured to store hot water, which means water with a temperature in excess of 70° C. Preferably, the amount of insulation in insulation layer 12 is sufficient for storing water at temperatures in the range of 95° C.-110° C., more preferably around 105° C. Providing such elevated temperatures in the buffer tank is required, because the liquid cools during transport to the dispensing means. It has been found that providing the mentioned temperature range in the buffer tank allows the liquid dispensed to the ground surface to be at a (desired) temperature of 99° C. or 100° C.

Direct supply line 16 extends between supply container 4 and buffer tank 10 and forms a direct connection that allows a flow of water from supply container 4 to buffer tank 10. Direct supply line 16 is in this example provided with supply pump 17, which is used to pump liquid to buffer tank 10. This is especially relevant if buffer tank 10 is a pressure vessel, because pump 17 is than used to provide the required pressure to transport liquid to buffer tank 10. For example, if buffer tank 10 is provided under a pressure of 2 bar, the pressure provided by pump 17 is around 3.5 bar. Direct supply line 16 is in this example provided with a number of mixing valves 18, which are connected to control unit 22 and temperature sensor or sensors 20 and/or temperature sensor 32 (see FIG. 2). This allows water to be provided to buffer tank 10. In this particular case, hot liquid supply line 24 emanates in direct supply line 16 before the joined flow enters buffer tank 10 at inlet 10a. It is of course possible to provide separate connections of direct supply line 16 and hot liquid supply line 24 to buffer tank 10. In this specific example, direct supply line 16 is provided with splitter 26, which is positioned upstream of mixing valves 18. As said, splitter 26 is connected to mixing valves 18 on the one side and to return line 28, which is emanates in hot liquid supply line 24 upstream of heating means 30. This allows at least part of the liquid from the direct supply line to be rerouted to the hot liquid supply line, and more specifically to heating means 30 positioned therein. In this example, return line 28 comprises pump 28a. Temperature sensor 32 is provided near or at splitter 26 to provide temperature data on the flow in direct supply line 16.

Hot liquid supply line 24 extends from supply container 4 to heating means 30 and onwards from heating means 30 to buffer tank 10. Hot liquid supply line 24 in this example comprises pump 34 to propel the water through supply line 24 towards buffer tank 10. It is noted however that pump 34 in some cases is not necessary. This is for example the case if supply container 4 is filled with warm or hot water from an external source. Heating means 30 in this example is provided as burner 30, yet may also be provided as electrical heater 30. Heating means 30 is provided with temperature sensor 36, which is configured to generate temperature information about the water flowing through heating means 30.

Apparatus 2 further comprises drain line 38, which connects an outlet of buffer tank 10 to an inlet of supply container 4. In this example, drain line 38 is provided with drain valve 40 or buffer draw valve 40 that allows hot water to be discharged from buffer tank 10 to supply container 4 in case the water level in buffer tank 10 exceeds a predetermined threshold. Drain line 38 therewith allows a supply of hot water through hot liquid supply line 24 without overfilling buffer tank 10. Due to drain line 38, hot water can be provided to supply container 4, which increases the temperature of the water stored in supply container 4. As a result, the energy required to heat the water from supply container 4 to buffer tank 10 (via hot liquid supply line 24) is reduced. Essentially, the heat in the hot water is largely conserved by the recirculation to supply container 4.

Apparatus 2 is further provided with (schematically shown) dispensing means 44 that are connected to an outlet of buffer tank 10 and to an inlet of buffer tank 10, which allow liquid to be circulated through dispensing means 44 even when no liquid is dispensed (see FIG. 1). Dispensing means 44 may for example comprise at least one ring-shaped line having dispensing openings. In another example, two ring-shaped lines may be provided. Each dispensing opening in may be provided with an associated discharge valve, which can be opened and closed to regulate the outflow of hot water. However, other configurations of dispensing means 44 may be possible as well.

Apparatus 2 in this example further also comprises (schematically shown) search and/or detection means 52 that are configured to search for and/or detect weed(s) W (see FIG. 2). This allows the hot water from dispensing openings 48 to be only discharged onto or in the direct vicinity of detected weed W plants. This reduces the amount of hot water required to remove weed W, since it is only applied locally.

In use of apparatus 2, a flow of water F from supply container 4 is provided to hot liquid supply line 24 to heating means 30 in which it is heated to become hot water. The hot water flow from heating means 30 is provided to buffer tank 10. Simultaneously, temperature sensor 20 measures the temperature of the flow of water towards inlet 10a of buffer tank 10. The signals of sensor or sensors 20 are processed by control unit 22, which regulates mixing valves 18 based on the temperature data provided by sensors 20 and, in this example, a predetermined temperature set-point. This means that water U from direct supply line 16 is selectively mixed with water flow F from hot liquid supply line 24 to provide hot water with a desired temperature. In this case, water flow F is mixed into water flow U. If the supply of hot water raises water level L in buffer tank 10 above a predetermined threshold Lₘₐₓ, drain valve 40 in drain line 38 is opened and hot water is discharged to supply container 4. This means that heating means 30 is operated to heat the relatively low volume, low pressure flow F of water in hot liquid supply line 24, allowing heating means 30 to operate at or near optimum capacity. It also allows heating means 30 to have a relatively low heat generating capacity. The regulation/control of the temperature in buffer tank 10 is executed by control unit 22 by regulating the flow U of water from direct supply line 16 to buffer tank 10 and/or the flow F from hot liquid supply line 24. This provides a significant reduction in energy use of apparatus 2.

Apparatus 2 preferably comprises control unit 22 that is configured to control one or more aspects of apparatus 2. In this example (see FIGS. 1 and 2), control unit 22 is configured to receive temperature signals from temperature sensors 14, 20, 32 and 36, which provide control input for control unit 22. Temperature information provided by the signals from temperature sensor 32 and/or 20 are for example used by control unit 22 to control mixing valves 18 to regulate the amount and/or temperature of the hot water in buffer tank 10. The regulation of the amount of hot water in buffer tank 10 may further also be regulated by control unit 22 by using drain valve 40. The dispensing means 44 are in this example mainly regulated by control unit 22 using input from search and/or detection means 52.

In a schematic side view (see FIG. 3), an example of apparatus 102 is provided on self-propelled vehicle 100. Vehicle 100 comprises driver cabin 156 being positioned on vehicle frame 158. In this example, vehicle 100 further comprises wheels 160 and an engine (not shown) that are connected to frame 158 to move vehicle 100 and apparatus 102 around. A front end of vehicle 100 is provided with dispensing means 144 and buffer tank 110 of apparatus 102, whereas supply container 104 of apparatus 102 is positioned on the back of vehicle 100 and is in this example enclosed in a separate housing 162 (and therefor only partially visible in FIG. 3). Housing 162 is optional and is not required. Buffer tank 110 is connected to supply container 104 by means of conduit 164. Dispensing means 144 are connected to buffer tank 110 and are used for supplying hot water to and returning (unused) hot water from and to buffer tank 110. It is noted that in the shown example (see FIG. 3), dispensing means 144 and buffer tank 110 are positioned on a separate frame 166 that is (preferably removably) connected to frame 158.

The present invention is by no means limited to the above described preferred embodiments thereof. The rights sought are defined by the following claims within the scope of which many modifications can be envisaged.

1. An apparatus for controlling a weed (W) growing on a ground surface (S), the apparatus comprising:
a liquid supply system configured to supply hot liquid; and
dispensing means operatively connected to the liquid supply system, wherein the dispensing means are configured to dispense the hot liquid to the weed on the ground surface (S);
wherein the liquid supply system comprises:
at least one buffer tank that is configured to store and supply the hot liquid;
a liquid supply container that is connected to the at least one buffer tank;
a direct supply line extending between the supply container and the at least one buffer tank, the direct supply line being configured to supply liquid from the supply container directly to the at least one buffer tank; and
a hot liquid supply line that includes heating means for heating the liquid supplied from the supply container to the at least one buffer tank.

2. The apparatus according to claim 1, further comprising a drain line that extends between the at least one buffer tank and the supply container and that is configured to discharge liquid from the at least one buffer tank to the supply container.

3. The apparatus according to claim 1, wherein the direct supply line comprises one or more mixing devices.

4. The apparatus according to claim 3, wherein the direct supply line comprises at least one signal-generating temperature sensor, wherein the mixing devices are configured to be controlled based on the signals generated by the at least one temperature sensor.

5. The apparatus according to claim 3, comprising a number of additional signal-generating temperature sensors.

6. The apparatus according to claim 1, wherein one or more of the hot liquid supply line, the direct supply line and/or the drain line are provided with a pump.

7. The apparatus according to claim 2, wherein the liquid supply system is configured to, during use of the apparatus, replenish the at least one buffer tank with hot liquid from the heating means, and to drain any excess liquid from the buffer via the drain line to the supply container in order to avoid overfilling of the buffer tank.

8. The apparatus according to claim 1, wherein the supply container and/or the at least one buffer tank are insulated.

9. The apparatus according to claim 2, wherein the hot liquid supply line is connected to the direct supply line downstream of the one or more mixing devices.

10. The apparatus according to claim 1, wherein the heating means comprise a number of burners and/or a number of electrical heating elements.

11. The apparatus according to claim 1, further comprising a frame that is configured to support the apparatus over the ground surface (S).

12. The apparatus according to claim 1, further comprising a control unit that is configured to control one or more of:
hot liquid distribution from the buffer tank to the dispensing means;
liquid supply from the supply container to the at least one buffer tank via the direct and/or hot liquid supply line.

13. The apparatus according to claim 1, further comprising search and/or detection means that are configured to search for and/or detect the weed (W), wherein the hot liquid is only dispensed onto or in the direct vicinity of detected weed (W) plants.

14. The apparatus according to claim 1, wherein the at least one buffer tank is a pressure tank that, during use, is pressurized, wherein the pressure is in the range of 0.2-4 bar.

15. A method for controlling weed (W) growing on a ground surface, comprising:
providing an apparatus according to claim 1;
during operation supplying hot liquid, via the hot liquid supply line, to the at least one buffer tank;
dispensing hot liquid, via the dispensing means, to weed on the ground surface that is to be controlled.

16. The method according to claim 15, further comprising the step of via the drain line draining excess liquid from the at least one buffer tank to the supply container to avoid overfilling of the buffer tank.

17. A liquid supply system that is configured to be used in an apparatus for controlling weeds (W) growing on a ground surface (S), the liquid supply system comprising:
at least one buffer tank that is configured to store and supply hot liquid;
a liquid supply container that is connected to the at least one buffer tank;
a direct supply line extending between the supply container and the at least one buffer tank, the direct supply line being configured to supply liquid from the supply container directly to the at least one buffer tank; and
a hot liquid supply line that includes heating means for heating the liquid supplied from the supply container to the at least one buffer tank.

18. The apparatus according to claim 3, wherein the one or more mixing devices comprise mixing valves.

19. The apparatus according to claim 3, wherein the one or more mixing devices comprise one or more temperature controlled mixing valves.

20. The apparatus according to claim 1, wherein the at one least buffer tank is a pressure tank that, during use, is pressurized, wherein the pressure is in the range of 1-3 bar.
